(19) United States
(12) Patent Application Publication
(10) Pub. No.: US 2024/0417119 A1
(43) Pub. Date: Dec. 19, 2024

(54) METHOD AND APPARATUS FOR FEEDING PRODUCTS OF THE TOBACCO INDUSTRY, PARTICULARLY SNUS, FROM A PRODUCTION MACHINE TO A PACKAGING MACHINE

(71) Applicant: SASIB S.p.A., Castel Maggiore (Bologna) (IT)

(72) Inventor: Roberto GHIOTTI, Castel Maggiore (Bologna) (IT)

(21) Appl. No.: 18/559,613

(22) PCT Filed: Mar. 17, 2022
(86) PCT No.: PCT/IB2022/052432

§ 371 Date: Nov. 8, 2023

(30) Foreign Application Priority Data
Mar. 26, 2021 (IT) 102021000007415

(51) Int. Cl. B65B 35/30; B65G 35/06; B65G 43/08; B65G 47/90

(52) U.S. Cl. CPC B65B 35/30; B65G 35/06; B65G 43/08; B65G 47/90; B65G 2201/0226

(57) ABSTRACT

A method for feeding products of the tobacco industry, particularly snus, from a production machine to a packaging machine, includes making the products advance along an advancement direction; and feeding to the packaging machine groups of products(S) having a predetermined number of products; wherein this feeding of groups of products includes: in a position for receiving the products, placing the products inside containers that are brought to the receiving position one after another, by depositing a predetermined number of products inside each container, so as to form, inside each container, a group of products of predetermined number; and transporting the containers containing the formed groups of products to a position for delivery of the products to the packaging machine.

### DESCRIPTION

The present invention relates to a method and an apparatus for feeding products of the tobacco industry, particularly snus, from a production machine to a packaging machine.

At the present time, snus from the production machine is transferred to a packaging machine which is limited to placing the snus in pre-formed rigid packages such as tins or cans.

This packaging machine adapts its operation to the operating cycle of the production machine, and therefore operates as a “slave” machine.

In other words, if the production machine stops, because of a malfunction or a maintenance operation, for example, the packaging machine also becomes inoperative.

In this context, the present invention proposes a novel solution for feeding snus—or, more generally, products of the tobacco industry—from a production machine to a packaging machine, this solution having a number of advantages over the aforementioned known solution, as will be seen subsequently.

In particular, the present invention relates to a method according to claim 1 and an apparatus according to claim 9.

The claims form an integral part of the teachings provided here.

Further characteristics and advantages of the invention will be apparent from the following description, which refers to the attached drawings provided purely by way of non-limiting example, in which:

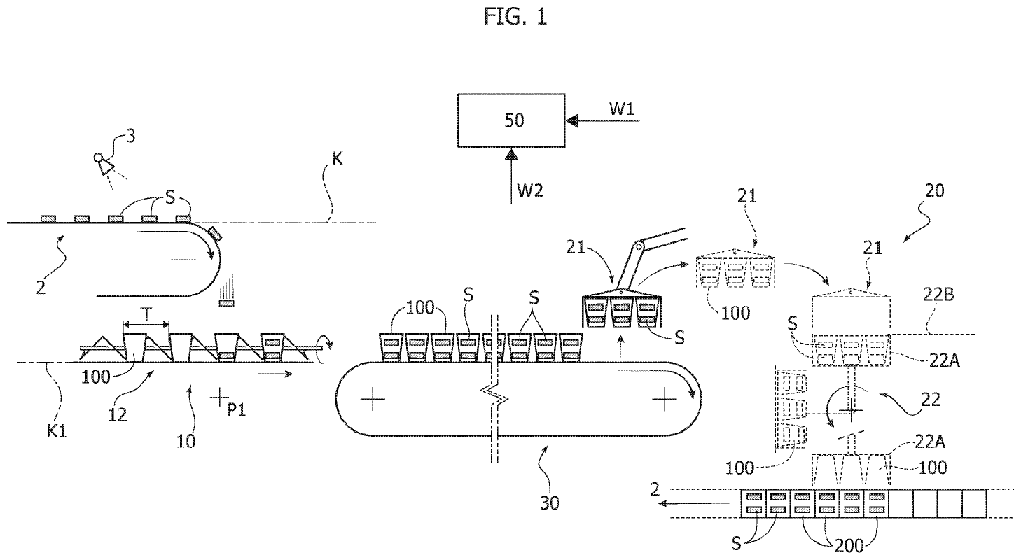

FIG. 1 shows schematically a first embodiment of the solution described here;

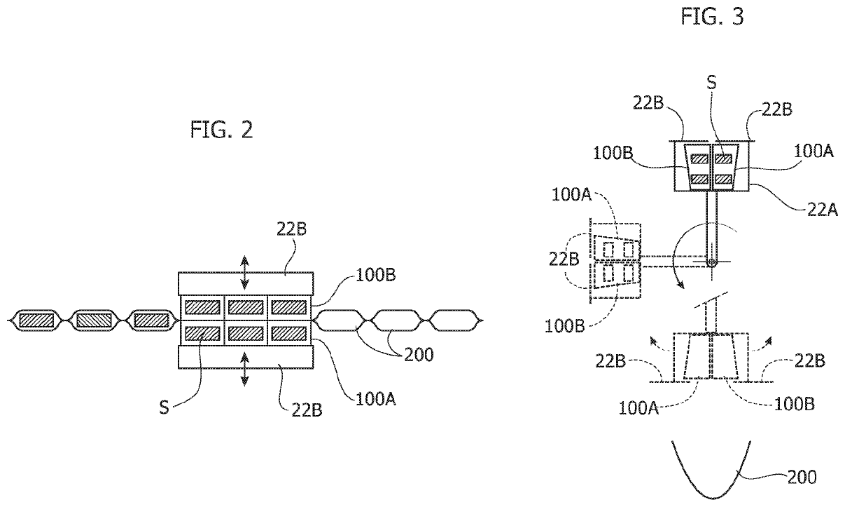

FIG. 2 shows a second embodiment of the solution described here, in a plan view;

FIG. 3 shows a side view of the solution of FIG. 2;

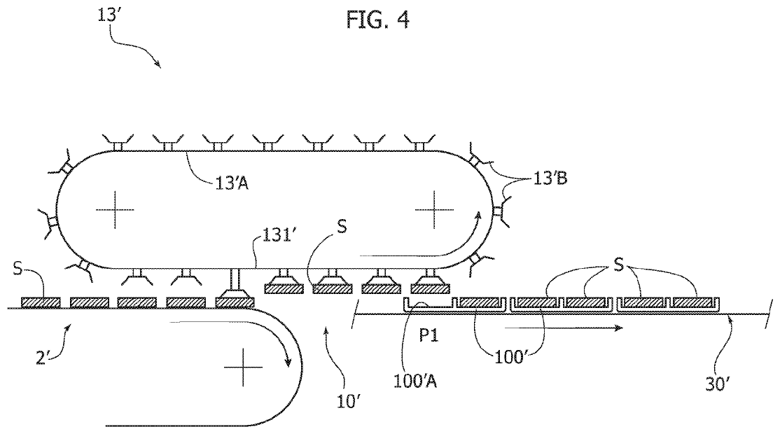

FIG. 4 shows a first station of the solution described here, according to a third embodiment;

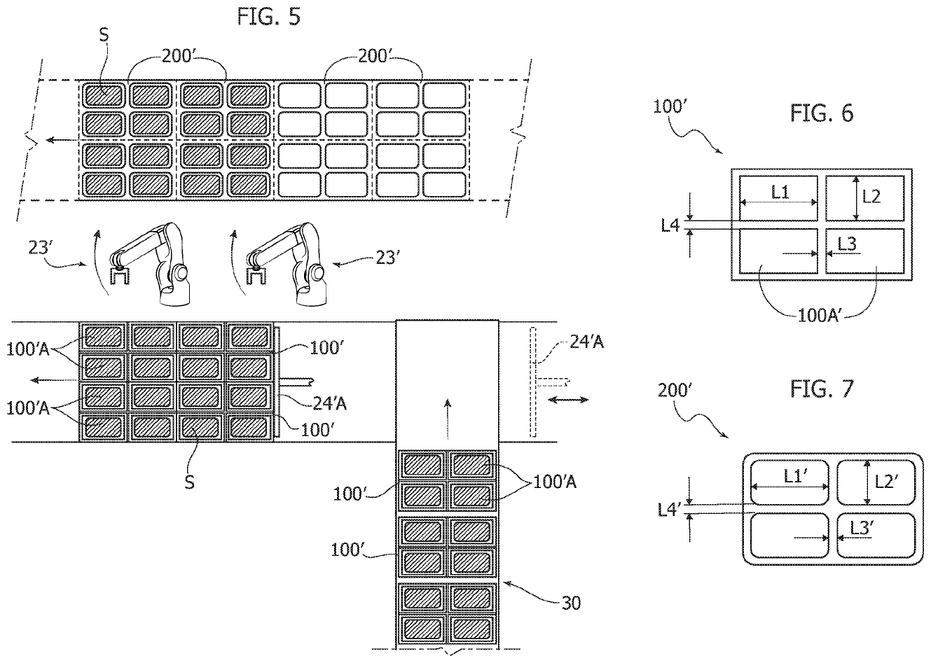

FIG. 5 shows a second station of the solution described here, according to a third embodiment;

FIG. 6 shows an example of a container used in the solution described here;

FIG. 7 shows an example of packaging.

The following description illustrates various specific details intended to provide a deeper understanding of the embodiments. The embodiments may be realized without one or more of the specific details, or with other methods, components or materials, etc. In other cases, known structures, materials or operations are not shown or described in detail, to avoid obscuring various aspects of the embodiment.

The references used here are purely for convenience and therefore do not define the scope of protection or the extent of the embodiments.

As mentioned above, the solution described here relates to a method and an apparatus for feeding products of the tobacco industry, particularly snus, from a production machine to a packaging machine.

In general terms, the method described here comprises:
making the products advance along a direction of advance; and
feeding to the packaging machine groups of products having a predetermined number of products;

wherein feeding groups of products includes:
in a position for receiving the products, placing the products inside containers that are carried successively to the receiving position, by depositing a predetermined number of products into each container, so as to form, inside each container, a group of products of predetermined number; and
transporting the containers containing formed groups of products to a position for delivering the products to the packaging machine.

The solution described here is characterized in that the containers used for transporting the products to the packaging machine are containers in which the groups of products to be packaged in individual packages have been formed in advance.

The containers filled with the groups of products formed in advance are fed to the packaging machine, and the groups of products are then transferred from the containers to corresponding packages.

The feeding of the containers to the packaging machine may be executed in accordance with the operating cycle of said packaging machine; on the other hand, it may be independent of the operating cycle of the production machine.

Because of the characteristics of the method described here, it is therefore also possible to carry out the packaging of the snus with packaging machines that operate according to predetermined operating cycles.

In a preferred embodiment, the packaging machine is a machine for packaging the products in packages for containing products in bulk, particularly sachets or pouches.

In another preferred embodiment, the packaging machine is a machine for packaging the products in blister packs.

Preferably, the filled containers are brought to the delivery position in successive groups of containers, each of which has a predetermined number of containers.

The number of containers may be determined on the basis of the operating parameters of the packaging machine, for example the duration of the operating cycle, the number of packages produced in a single operating cycle, etc.

With reference to FIG. 1, this shows a preferred embodiment of the solution described here for applications in which the packaging machine is a machine for packaging products in sachets.

The illustrated apparatus comprises:
a plurality of containers 100 for receiving the products S made by the production machine;
a first station 10 for feeding containers 100, for bringing empty containers 100 in succession to a position P1 for receiving the products made by the production machine;
a second station 20 for bringing the containers 100, each of which contains a predetermined number of products, to a position P2 for delivering the products S to the packaging machine;
at least one conveyor 30 for transporting the containers 100 from the first to the second feeding station.

In the illustrated example, the products S leaving the production machine are brought to the receiving position P1 by a conveyor 2, a conveyor belt for example, on which the products S advance (being contained in the containers 100) along a direction of advance K, being ordered in line along the same direction.

The products S sent to the position P1 are counted by means of a sensor 3.

The feeding station 10 brings the containers 100 to the position P1 in an area below the conveyor 2, so that the products reaching the end of the conveyor 2 are discharged by gravity into the container 100 that is located in the position P1 at that moment.

The products S are discharged into the same container 100 until a predetermined number of products is reached in the container.

Thus a predetermined group of products is formed (in disordered bulk form) in each container.

In a preferred embodiment, the first feeding station 10 comprises a screw conveyor device 12 for moving the containers 100 along a direction of advance K1, keeping the containers in line and spaced from one another by a predetermined interval T.

The conveyor device 12 enables the empty containers 100 to be freshly supplied as necessary in the position P1, ensuring optimal synchronization with the conveyor 2.

The apparatus comprises a control unit 50 that is configured for receiving a signal W1 indicative of a number of products that have reached the receiving position P1, and for controlling the first feeding station 10 in accordance with this signal in order to keep each container 100 in the position P1 until a predetermined number of products has been deposited in the container 100.

In a preferred embodiment, the second feeding station 20 comprises:
a picking device 21 for picking a predetermined number of containers 100 simultaneously from the conveyor 30; and
an overturning unit 22, located at the delivery position P2, for receiving the predetermined number of containers 100 from the picking device 21 and overturning them simultaneously so as to discharge the respective groups of products into a corresponding number of packages fed to the delivery position P2 by the packaging machine.

As shown schematically in FIG. 1, the picking device 21 comprises a collecting head capable of gripping a plurality of containers simultaneously. In operation, the number of containers gripped will be equal to the aforesaid predetermined number.

Similarly, the overturning unit 22 comprises a housing 22A designed to receive, all together, the group of containers 100 picked by the device 21.

The overturning unit 22 is positioned over an advance path Z along which there advances a succession of preformed sachets 200 fed by the packaging machine, passing through the position P2.

With reference to conventional packaging machines, the succession of sachets 200 may be produced from a strip of wrapping foil unwound from a reel, the strip being folded along a longitudinal folding line and welded along an ordered series of transverse sealing lines.

In the position P2, the individual sachets 200 are still open at the top so that they can receive the groups of products discharged from the containers 100 by means of the unit 22.

The belt and the succession of sachets formed by it usually advance with a stepping movement. The operating cycle of the feeding station 20 will depend on the cycle of this movement.

In particular, the second feeding station 20 will be synchronized to turn over a new group of containers 100 at each interval between one step and the next.

In general terms, the control unit 50 is configured to receive at least a signal W2 that is indicative of a parameter of an operating cycle of the packaging machine, and to control the feeding station 20 according to this signal.

In a preferred embodiment (see FIGS. 2 and 3), the containers 100 each comprise a first and a second compartment 100A, 100B for receiving two separate groups of products.

In the receiving position P1, a first group of products is discharged into the compartment 100A (in disordered bulk form), and a second group of products is discharged into the compartment 100B (in disordered bulk form).

In this connection, the conveyor 2 preferably operates to feed two parallel lines of products S (not shown), each for filling a respective compartment of the two compartments 100A, 100B.

Also with reference to the preferred embodiment mentioned, in the delivery position P2, the overturning unit 22 operates to discharge first the groups of products from the compartments 100A of the group of containers received in the overturning unit, and then the group of products from the compartments 100B, or vice versa.

For this purpose, the overturning unit 22 may be provided with two independently operable closing members 22B, for selectively opening and closing the upper apertures of the compartments 100A, 100B of the group of containers 100 received in the overturning unit 22.

The groups of products from the compartments 100A are discharged into a corresponding number of sachets 200, brought to the position P2 by the packaging machine.

The groups of products from the compartments 100B are discharged into other sachets 200, subsequently fed to the position P2 by the packaging machine.

In the light of the above description, it will be apparent that the number of compartments of the individual containers 100 may be defined on the basis of operating parameters of the packaging machine.

FIGS. 4 and 5 show an embodiment of the solution described here for packaging products in blister packs.

In this application, the individual container 100′ comprises a plurality of compartments 100A′, each intended to receive a product, so as to form an ordered group of products.

Preferably, the plurality of compartments 100A′ reproduces the array of cells of the blister packs 200′ formed by the packaging machine.

For example, with reference to FIGS. 6 and 7, each compartment 100A′ may have dimensions L1, L2 that are substantially equal to the dimensions L1′, L2′ of the individual cell of the blister pack, and the distances L3, L4 between each compartment and the adjacent compartments may be substantially equal to the analogous distances L3′ and L4′ between the cells of the blister pack.

The first feeding station 10′ may have the same configuration as that described above with reference to the embodiment of FIG. 1.

Alternatively (see FIG. 4), the feeding station 10′ may comprise a picking device for picking the snus from the conveyor 2′ and transferring it into corresponding compartments 100A′ in containers 100′ that advance on a conveyor 12′.

In a preferred embodiment, the picking device 13′ comprises a ring conveyor 13′A on which a plurality of picking members 13′B are moved.

The ring conveyor 13′A has a portion 131′ that is located both above a terminal portion of the conveyor 2′ and above a portion del conveyor 30′ immediately following the conveyor 10.

During their movement along the portion 131′, each of the picking members 13′B picks a respective product from the conveyor 2′, and deposits it in a vacant compartment 100A′ of a container 100′ that is positioned on the conveyor 30′ and is in the receiving position P1′ at that instant.

During these operations, the containers 100′ on the conveyor 30′ and the products S on the conveyor 10 can advance with a continuous movement.

Thus it is possible to achieve high volumes of products loaded into the containers 100% per unit of time.

It will also be apparent that, in this case, the receiving position P1′ is considered to be the area in which the transfer of the products S to the containers 100′ takes place.

In a preferred embodiment, the feeding station 20′ comprises one or more pick-and-place devices 23′, for transferring the products from the containers 100′ that have reached the delivery position P2′ into respective cells of blister packs 200′ that are fed by the packaging machine along a path of a advance adjacent to the position P2′.

In a preferred embodiment, the feeding station 20′ further comprises a conveyor 24′ designed to make the containers 100′ advance in a compact formation which reproduces a tray 102′ having a total number of compartments that is equal to a multiple of the number of compartments of a single container 100′. The tray 102′ supplies the products S to the pick-and-place devices 23′.

In a similar manner to what is described above, the delivery position P2′ in this case is considered to be the area in which the products S are picked from the containers 100′.

The conveyor 24′ may, for example, be an accumulation conveyor of a known type. Also by way of example, one or more pusher members 24′A may be associated with the conveyor 24′, to implement the transfer of the containers 100′ thereto from the conveyor 30′.

The dimensions of the tray 102′ that is produced may be defined on the basis of operating parameters of the packaging machine.

Also according to this embodiment, the control unit (not shown) is preferably configured to operate the feeding station 10′ in accordance with a signal indicative of a number of products that has reached the receiving position P1′, and to control the feeding station 20′ in accordance with at least one signal indicative of a parameter of the operating cycle of the packaging machine.

Clearly, provided that the principle of the invention is retained, the details of construction and forms of embodiment can be varied, even to a significant degree, from what has been illustrated herein purely by way of non-limiting example, without thereby departing from the scope of the invention, as defined in the attached claims.

1. A method for feeding products of a tobacco industry, including snus, from a production machine to a packaging machine, the method comprising:
making the products advance along an advancement direction;
feeding to the packaging machine groups of products having a predetermined number of the products;
wherein feeding groups of products includes:
in a receiving position for receiving the products, placing the products inside containers that are brought to the receiving position one after another, by depositing a predetermined number of the products inside each container, so as to form, inside each container, a group of products of the predetermined number; and
transporting the containers containing the groups of products to a delivery position for delivery of the products to the packaging machine.

2. The method according to claim 1, wherein the packaging machine is a machine for packaging the products in packages for containing products in bulk, including sachets or pouches, the method including:
in the receiving position, unloading the products into one single container one product after another until a number of products equal to the predetermined number of the products has been reached, so as to form the group of products of the predetermined number; and
in the delivery position, unloading the group of products from the container that is in the delivery position into a package that is fed to the delivery position by the packaging machine.

3. The method according to claim 2, wherein:
transporting the containers to the delivery position includes bringing to the delivery position, one after another, groups of containers each having a predetermined number of containers; and
in the delivery position, unloading the groups of products of a group of containers of the groups of containers that is in the delivery position contemporarily into corresponding packages fed to the delivery position by the packaging machine.

4. The method according to claim 3, wherein each container comprises at least a first and a second compartment, the method including:
in the receiving position, unloading a first group of products inside the first compartment of the container that is in the receiving position, and unloading a second group of products into the second compartment of the container that is in the receiving position; and
in the delivery position, unloading, in a first step, the first group of products of the container that is in the delivery position into the package that is fed to the delivery position by the packaging machine, and, in a successive step, unloading the second group of products of the same container that is the delivery position into a further package that is successively brought to the delivery position by the packaging machine.

5. The method according to claim 3, wherein:
transporting the containers to the delivery position includes bringing to the delivery position successive groups of containers that, each, have the predetermined number of containers; and
in the delivery position, unloading, in a first step, the first group of products of the group of containers that is in the delivery position, contemporarily, into corresponding packages that are fed to the delivery position by the packaging machine, and, in a successive step, unloading the second group of products of the same group of containers that is in the delivery position, contemporarily, into further packages that are successively brought to the delivery position by the packaging machine.

6. The method according to claim 1, wherein the packaging machine is a machine for packaging products in blisters, and wherein the container comprises a plurality of compartments, the method including:
in the receiving position, transferring at least one product into each compartment of the plurality of compartments of one single container until all the plurality of compartments of the one single container are occupied, so as to form an orderly-arranged group of products in the one single container.

7. The method according to claim 6, including, by means of a pick-and-place device, transferring single products arranged in the plurality of compartments of the one single container into respective receptacles made on a band that is fed by the packaging machine to the delivery position.

8. The method according to claim 6, wherein transporting containers to the delivery position includes arranging the containers in a compact formation wherein they form a tray having a number of compartments that is equal to a multiple of the plurality of compartments of the one single container.

9. An apparatus for feeding products of the tobacco industry, including snus, from a production machine to a packaging machine, the apparatus comprising:
a plurality of containers for receiving products made by the production machine;
a first station for feeding containers of the plurality of containers for bringing in succession empty containers to a receiving position for receiving products made by the production machine;
a second station for feeding the containers for bringing the containers, each of which contains a predetermined number of products, to a delivery position for delivery of the products to the packaging machine; and
at least one conveyor for transporting the containers from the first station to the second station.

10. The apparatus according to claim 9, comprising:
at least one control unit,
wherein the control unit is configured to receive a first signal that is indicative of a number of products that have reached the receiving position, and for controlling the first station as a function of the first signal for keeping each container in the receiving position until a number of products equal to the predetermined number has been deposited into each container, and
wherein the control unit is configured to receive a second signal that is indicative of a parameter of a work-cycle of the packaging machine, and to control the second station as a function of the second signal for bringing the containers containing the products, in a manner that is synchronized with a feeding of packages by the packaging machine, to or near the delivery position.

11. The apparatus according to claim 9, wherein the second station is configured to bring the containers to the delivery position, in successive groups, each having a predetermined number of containers.

12. The apparatus according to claim 9, wherein the first station comprises a screw conveyor device for moving the containers along a direction of advancement keeping the containers in line and spaced from one another by a predetermined pitch.

13. The apparatus according to claim 9, wherein the second station comprises:
a picking device for contemporarily picking a predetermined number of containers, and
a unit for overturning, which is at the delivery position, for receiving the predetermined number of containers from the picking device, and overturning them contemporarily so as to unload the respective groups of products into corresponding packages fed to the delivery position by the packaging machine.

14. The apparatus according to claim 9, wherein the second station comprises a conveyor for making the containers advance according to a compact formation in which the containers form a tray having a number of compartments that is equal to a multiple of a number of compartments of a single container.

15. A system for producing and packaging products of the tobacco industry, including snus, comprising:
a machine for producing the products of the tobacco industry;
a machine for packaging the products of the tobacco industry; and
an apparatus for feeding the products of the tobacco industry from the production machine to the packaging machine, according to claim 9.
